(19) United States
(12) Patent Application Publication
(10) Pub. No.: US 2026/0260019 A1
(43) Pub. Date: Sep. 3, 2026

(54) Systems and Methods for AI Application Data Reliability Analysis and Remediation in a Database System

(71) Applicant: PeerNova, Inc., San Jose, CA (US)

(72) Inventors: Abraham Lloyd, San Jose, CA (US); Mehmet Orun, Philadelphia, PA (US)

(21) Appl. No.: 19/553,629

(22) Filed: Mar. 2, 2026

Related U.S. Application Data
(60) Provisional application No. 63/765,323, filed on Feb. 28, 2025.

(51) Int. Cl. G06F 21/62; G06F 16/35

(52) U.S. Cl. CPC G06F 21/629; G06F 16/35

(57) ABSTRACT

A system may include at least one processor, a memory storing executable instructions, and a database system storing structured data records. Execution of the instructions by the at least one processor may cause the system to: identify a designated artificial intelligence application configured to use data stored in the database system; identify a plurality of database fields associated with the designated artificial intelligence application; for each of the plurality of database fields, determine: (i) a field utilization percentage, (ii) a distinct value density percentage, and (iii) a freshness value based on update timing associated with the field; determine, for each of the plurality of database fields, a generative risk value based at least in part on the field utilization percentage and the freshness value; and for each structured data record, determine a record-level reliability score.

### CROSS-REFERENCE TO RELATED APPLICATIONS

This application claims the benefit under 35 U.S.C. § 119(e) of US Provisional Patent Application 63/765,323 (Attorney Docket No. PRNVP003P) by Abraham Lloyd, titled: “AI Application Data Reliability Analysis and Remediation in a Database System”, filed on February 28, 2026, which is incorporated herein by reference in its entirety for all purposes.

### FIELD OF TECHNOLOGY

This patent application relates generally to database systems, and more specifically to AI-related applications within database systems.

### BACKGROUND

Organizations increasingly rely on automated systems, analytics engines, and artificial intelligence models to generate decisions, recommendations, communications, and other operational outputs based on structured enterprise data. These systems often operate over large volumes of records stored in databases or data platforms that were originally designed for transactional purposes rather than analytical or generative processing. As automation becomes more tightly integrated into core business functions, the quality and reliability of underlying data directly affect the accuracy, safety, and business impact of automated outcomes.

However, enterprise data repositories frequently contain incomplete, inconsistent, outdated, or sparsely populated fields. Data may be entered manually, integrated from multiple upstream systems, or transformed across various pipelines, each introducing potential inconsistencies or ambiguities. Conventional data quality efforts typically focus on isolated metrics, such as field completeness or duplicate detection, without systematically assessing whether a given dataset is suitable for a particular automated use case. As a result, data that appears structurally valid at a schema level may nevertheless be inadequate to support reliable automated reasoning or generative processing.

Moreover, generative and inference-based systems are particularly sensitive to gaps, ambiguities, and latent inconsistencies in source data. Inadequate input data may increase the likelihood of unsupported inferences, speculative outputs, or so-called hallucinations, especially when such systems attempt to synthesize content or derive conclusions beyond explicitly stored values. Existing tools generally lack mechanisms to quantify readiness of specific subsets of data for defined automated tasks, or to continuously monitor whether data conditions remain suitable over time. These limitations create operational risk and constrain the safe deployment of advanced automation technologies in enterprise environments.

### SUMMARY

In some embodiments, the techniques described herein relate to a system including: at least one processor; a memory storing executable instructions; and a database system storing structured data records, wherein execution of the instructions by the at least one processor causes the system to: identify a designated artificial intelligence application configured to use data stored in the database system; identify a plurality of database fields associated with the designated artificial intelligence application; for each of the plurality of database fields, determine: (i) a field utilization percentage, (ii) a distinct value density percentage, and (iii) a freshness value based on update timing associated with the field; determine, for each of the plurality of database fields, a generative risk value based at least in part on the field utilization percentage and the freshness value; for each structured data record, determine a record-level reliability score based on one or more of: (i) the generative risk values of fields included in the structured data record, (ii) a completeness value associated with the structured data record, and (iii) a freshness value associated with the structured data record; divide the structured data records into a plurality of data segments; for each of the plurality of data segments, determine a segment-level reliability metric based on an aggregation of record-level reliability scores for structured data records included in the data segment; store the generative risk values, the record-level reliability scores, and the segment-level reliability metrics as data reliability indicators within the database system; and control execution of the designated artificial intelligence application based on the segment-level reliability metric.

In some embodiments, the techniques described herein relate to a system, wherein the field utilization percentage represents a percentage of structured data records in which a field contains a non-empty value.

In some embodiments, the techniques described herein relate to a system, wherein the distinct value density percentage represents a number of distinct values stored in a field divided by a total number of structured data records or non-empty values.

In some embodiments, the techniques described herein relate to a system, wherein determining the generative risk value includes applying a weighted aggregation of multiple field-level reliability metrics.

In some embodiments, the techniques described herein relate to a system, wherein the record-level reliability score includes a weighted combination of: (i) a contact information completeness value, (ii) a sales information completeness value, and (iii) a freshness value.

In some embodiments, the techniques described herein relate to a system, wherein dividing the structured data records into the plurality of data segments includes grouping the structured data records based on at least one of: (i) a geographic attribute, (ii) a record type, (iii) a creation date, and (iv) a reliability value band.

In some embodiments, the techniques described herein relate to a system, wherein controlling execution of the designated artificial intelligence application includes restricting use of the artificial intelligence application to data segments having segment-level reliability metrics that satisfy a predefined threshold.

In some embodiments, the techniques described herein relate to a system, wherein controlling execution of the designated artificial intelligence application includes preventing execution of the artificial intelligence application for structured data records having record-level reliability scores below a predefined threshold.

In some embodiments, the techniques described herein relate to a system, wherein the artificial intelligence application includes a generative language model configured to generate text based on structured data stored in the database system.

In some embodiments, the techniques described herein relate to a computer-implemented method performed by at least one processor in communication with a database system storing structured data records, the method including: identifying a designated artificial intelligence application configured to use data stored in the database system; identifying a plurality of database fields associated with the designated artificial intelligence application; for each of the plurality of database fields, determining: (i) a field utilization percentage, (ii) a distinct value density percentage, and (iii) a freshness value based on update timing associated with the field; determining, for each of the plurality of database fields, a generative risk value based at least in part on the field utilization percentage and the freshness value; for each structured data record, determining a record-level reliability score based on one or more of: (i) the generative risk values of fields included in the structured data record, (ii) a completeness value associated with the structured data record, and (iii) a freshness value associated with the structured data record; dividing the structured data records into a plurality of data segments; for each of the plurality of data segments, determining a segment-level reliability metric based on an aggregation of record-level reliability scores for structured data records included in the data segment; storing the generative risk values, the record-level reliability scores, and the segment-level reliability metrics as data reliability indicators within the database system; and controlling execution of the designated artificial intelligence application based on the segment-level reliability metric.

In some embodiments, the techniques described herein relate to a method, wherein the field utilization percentage represents a percentage of structured data records in which a field contains a non-empty value.

In some embodiments, the techniques described herein relate to a method, wherein the distinct value density percentage represents a number of distinct values stored in a field divided by a total number of structured data records or non-empty values.

In some embodiments, the techniques described herein relate to a method, wherein determining the generative risk value includes applying a weighted aggregation of multiple field-level reliability metrics.

In some embodiments, the techniques described herein relate to a method, wherein the record-level reliability score includes a weighted combination of: (i) a contact information completeness value, (ii) a sales information completeness value, and (iii) a freshness value.

In some embodiments, the techniques described herein relate to a method, wherein dividing the structured data records into the plurality of data segments includes grouping the structured data records based on at least one of: (i) a geographic attribute, (ii) a record type, (iii) a creation date, or (iv) a reliability value band.

In some embodiments, the techniques described herein relate to a method, wherein controlling execution of the designated artificial intelligence application includes restricting use of the artificial intelligence application to data segments having segment-level reliability metrics that satisfy a predefined threshold.

In some embodiments, the techniques described herein relate to a method, wherein controlling execution of the designated artificial intelligence application includes preventing execution of the artificial intelligence application for structured data records having record-level reliability scores below a predefined threshold.

In some embodiments, the techniques described herein relate to a method, wherein the artificial intelligence application includes a generative language model configured to generate text based on structured data stored in the database system.

In some embodiments, the techniques described herein relate to one or more non-transitory computer-readable media having an instruction stored thereon for performing a computer-implemented method performed by at least one processor in communication with a database system storing structured data records, the method including: identifying a designated artificial intelligence application configured to use data stored in the database system; identifying a plurality of database fields associated with the designated artificial intelligence application; for each of the plurality of database fields, determining: (i) a field utilization percentage, (ii) a distinct value density percentage, and (iii) a freshness value based on update timing associated with the field; determining, for each of the plurality of database fields, a generative risk value based at least in part on the field utilization percentage and the freshness value; for each structured data record, determining a record-level reliability score based on one or more of: (i) the generative risk values of fields included in the structured data record, (ii) a completeness value associated with the structured data record, and (iii) a freshness value associated with the structured data record; dividing the structured data records into a plurality of data segments; for each of the plurality of data segments, determining a segment-level reliability metric based on an aggregation of record-level reliability scores for structured data records included in the data segment; storing the generative risk values, the record-level reliability scores, and the segment-level reliability metrics as data reliability indicators within the database system; and controlling execution of the designated artificial intelligence application based on the segment-level reliability metric.

In some embodiments, the techniques described herein relate to one or more non-transitory computer-readable media, wherein the field utilization percentage represents a percentage of structured data records in which a field contains a non-empty value.

These and other embodiments are described further below with reference to the figures.

### BRIEF DESCRIPTION OF THE DRAWINGS

The included drawings are for illustrative purposes and serve only to provide examples of possible structures and operations for the disclosed inventive systems, apparatus, methods, and computer program products for AI application data reliability analysis and remediation. These drawings in no way limit any changes in form and detail that may be made by one skilled in the art without departing from the spirit and scope of the disclosed implementations.

FIG. 1 illustrates a method of performing a data reliability analysis, performed in accordance with one or more embodiments.

FIG. 2 illustrates a method for determining data segment reliability data, performed in accordance with one or more embodiments.

FIG. 3 illustrates one example of a computing device, configured in accordance with one or more embodiments.

FIG. 4 illustrates a user interface displaying a set of database records accessible via a database system.

FIG. 5 through FIG. 15 illustrate user interfaces generated in accordance with one or more embodiments.

FIG. 16 illustrates a data reliability analysis and remediation method, performed in accordance with one or more embodiments.

FIG. 17 illustrates a data segment selection method, performed in accordance with one or more embodiments.

FIG. 18 illustrates a block diagram of data field indicators within a set of data segments, configured in accordance with one or more embodiments.

### DETAILED DESCRIPTION

### Introduction

According to various embodiments, the disclosed technology provides automated techniques to assess and improve the reliability of data stored in database systems for use in artificial intelligence applications. The system determines and stores record-level, field-level, and segment-level data reliability indicators that evaluate attributes such as completeness, freshness, uniqueness, and hallucination risk. Data segments that meet defined reliability criteria may be identified for immediate use in generative or predictive AI systems, while unreliable segments may be flagged for remediation. The methods may also monitor changes in reliability over time to maintain consistent AI performance. These techniques may be implemented across a variety of computing services environments, enabling improved accuracy and stability of AI-generated outputs.

Generative AI is poised to foster seismic changes to human productivity. Each year sees great leaps forward in both the performance and application of generative models, and particular in the growth of generative language models. However, a fundamental technical obstacle to the application of generative language models is the availability of reliable data. For example, many generative language model applications rely on data retrieved from database systems. However, such data may be randomly or systematically stale, incomplete, inaccurate, uninformative, or otherwise unreliable. In the absence of reliable data, generative models may generate output that is just as unreliable, particularly given that, lacking the context available to human actors, generative models typically take at face value data that they have received. For instance, faced with a last-updated date of more than a century in the past, a generative language model may produce unanticipated results when tasked to craft a communication based on the data record, whereas a human would immediately deduce that the last-updated date was almost certain erroneous and ignore or correct the value before proceeding. More generally, unreliable data may lead to hallucinations and other inaccurate or unreliable output. Because of these problems, the lack of data known to be reliable is perhaps the single largest impediment to the widespread adoption of generative models.

Despite the significant gains to be realized by overcoming data reliability obstacles, conventional techniques are insufficient at resolving these challenges. For instance, subdividing data into portions that are reliable or unreliable, improving or static, fresh or stale, informative or uninformative, or otherwise reliable or unreliable is currently a highly manual process. Moreover, to be effective in solving problems, generative models rely on massive quantities of data, the analysis of which is far beyond the scope of what could be accomplished via manual human processes. Hence, data reliability in the artificial intelligence context presents a significant technical challenge for which additional technical solutions are needed.

Large-scale database systems that power AI applications frequently suffer from unreliable or inconsistent data. Data stored across multiple tables and schemas may include stale timestamps, empty fields, or contradictory values. These data issues can propagate through machine learning workflows, causing unpredictable outputs. The latency introduced by repeated data retrieval and manual verification processes increases with database size, leading to performance bottlenecks. In generative or predictive AI use cases, this unreliability results in degraded model precision and recall, as the system trains or generates content on inaccurate or incomplete data.

Another technical problem arises from the inability of conventional systems to quantify or classify data reliability in real time across multiple fields and segments. Typical profiling procedures require manual SQL queries or static rule sets executed at infrequent intervals. Such processes cannot provide granular differentiation across subpopulations of the data that vary by source, geography, or update frequency. This limitation causes missed detection of local reliability trends and delays in identifying data anomalies. It also increases the cost and duration of data processing cycles because complete datasets must be reanalyzed instead of targeted subsets.

A further technical issue concerns maintaining sustained reliability metrics in dynamic environments. Database records are frequently updated by distributed processes and external integrations. These asynchronous updates can lead to race conditions where old and new data coexist temporarily, distorting freshness indicators and generating incorrect analysis results. Without continuous tracking mechanisms, existing database systems lack the capability to measure and update reliability indicators efficiently. This leads to incomplete or outdated metrics, which directly affect model calibration and prediction confidence.

Existing infrastructure also faces challenges in computation throughput and scalability when evaluating reliability indicators for large data sets. Calculating completeness, distinct densities, or default usage patterns across millions of records consumes significant memory and CPU resources. The lack of structured reliability indicators across record-level and field-level granularity increases processing complexity and compute cost. This inefficiency makes it impractical to maintain up-to-date reliability assessments in real-time AI pipelines.

Finally, conventional remediation workflows are fragmented across tools, requiring human intervention for record review and field correction. Manual review processes cause high latency, error-prone decision-making, and inconsistent reporting formats across applications. As a result, the overall precision of AI-generated content degrades because uncorrected errors in key data fields feed directly into model inputs, reducing the trustworthiness of downstream AI operations.

According to various embodiments, techniques and mechanisms disclosed herein provide for automated solutions to data reliability challenges. Data reliability indicators measure the extent to which data stored in a database system can lead to reliable generative AI outcomes. Such indicators can measure the completeness, freshness, hallucination risk, and data dictionary importance of fields powering agentic AI use-cases. Such indicators can be incorporated into agent-based actions to leverage the data reliability context in generative outcomes. Data segments ready for agentic AI use-cases can be readily identified through reliability scoring and classification. Data segments requiring quality improvements can be readily identified. Reliability trends across data segments can be monitored to maintain high-quality AI performance over time.

According to various embodiments, techniques and mechanisms described herein may be suitable for measuring and improving data reliability for a range of applications. One example of such an application is agentic AI, which employs generative language models to determine actions and generate text, and many examples discussed herein are described in reference to generative and/or agentic AI. However, techniques and mechanisms described herein are broadly applicable to other situations as well, such as in the application of predictive machine learning models or applications outside of machine learning and artificial intelligence.

In some embodiments, the system operates within a computing services environment that provides access to one or more database systems storing structured records. The system identifies an application such as a generative or predictive AI service that relies on these records. It then detects corresponding database objects and fields relevant to the application based on metadata, schema configurations, or user input. The identified fields may include both structured and unstructured attributes such as numeric data, categorical data, or free text. The system proceeds to compile these objects and fields into a profile used for systematic analysis of data reliability metrics.

In one or more embodiments, the system determines multiple levels of data reliability indicators. Record-level indicators may quantify the reliability of individual records for a particular application. Field-level indicators may evaluate all instances of a field across a dataset, providing insight into data completeness, distinct value density, default usage, or duplication frequency. Segment-level indicators may represent aggregated reliability metrics for subsets of the dataset defined along parameters such as geography, record type, or creation date. Each indicator may be represented as a numerical value or probability score stored alongside corresponding database entries.

In some implementations, the reliability metrics may be determined using declarative logic or dynamic formula fields. For example, a database formula field may calculate a “contact completeness percentage” by aggregating counts of verified email addresses or recently updated contact details. Another formula field may compute a “freshness percentage” representing the frequency of updates within a recent time window. These computed values may be stored directly in database tables for reuse by machine learning systems or administrative dashboards. Such formula-based indicators allow consistent metric reuse without altering the core structure of database records.

According to various embodiments, a profiling layer may include a sequence of automated operations that analyze the structural and statistical properties of the identified fields. This analysis may include determining low-level field utilization statistics and deriving high-level composite measures such as a “segment score.” The segment score may be computed as a weighted aggregate of multiple field- and record-level indicators, providing a single metric representing the readiness of a dataset portion for AI processing. These computations may be performed periodically or triggered on demand by user interaction.

In one or more embodiments, a segment scoring module may automatically partition data into logical segments for granular assessment. Segments may be formed based on data distribution or classification criteria determined by the system. For example, the module may generate partitions corresponding to records updated within the last six months versus those updated earlier, or accounts located in different geographic regions. Each segment may be assigned a reliability vector including multiple attribute-level scores. These segmented metrics allow targeted monitoring and improvement of subpopulations of the dataset.

In some embodiments, the computing environment may include a monitoring workflow that tracks the evolution of reliability indicators over time. The workflow may execute on a fixed schedule or in response to database updates, recalculating record-level and segment-level values to ensure that current data reflects recent changes. The system may maintain a time series of reliability scores so trends can be visualized or analyzed programmatically. For example, a freshness band view may display how many records fall within defined intervals of update recency, and may visualize decline or improvement over successive time periods.

In various embodiments, a user interface allows configuration, visualization, and interaction with the data reliability model. A profiling definition wizard may guide users through selecting fields to analyze, assigning definitions and categories, and linking outcome variables to performance indicators. The interface may display record- and segment-level reliability values in table or graph formats. Users may filter or sort by field type, indicator range, or performance threshold. An administrative dashboard may also represent the percentage of records having a confidence score above or below a defined threshold.

In some implementations, the system employs a data reliability object structure stored directly within the database. These objects may include persistent fields representing reliability indicators such as “email confidence” or “hallucination risk”. A change in any contributing data input automatically triggers recalculation of the corresponding reliability fields. This object model enables downstream generative models to consume reliability data through existing API calls, allowing a consistent integration framework between the database and AI processing layers.

According to various embodiments, the system architecture may include a processor, memory, and storage system connected through a communication bus. Software modules implemented within the memory may perform operations such as field analysis, reliability scoring, and segmentation. The processor executes stored instructions to query databases, perform calculations, and populate result records. A network interface facilitates data exchange with external AI services or monitoring tools. The resulting data reliability metrics may be transmitted or consumed by external analytics engines or process automation services.

In one or more embodiments, historical reliability data may be visualized through graphical displays showing shifts in indicator bands, segment-level summaries, or trend charts. For instance, a histogram may display the number of records falling into defined confidence intervals, while a line graph may show the rate of change in data completeness across multiple evaluation runs. Such visualization assists in identifying which fields deteriorate or improve over time. The underlying dataset supporting the visualization may be updated automatically during each analysis cycle, ensuring consistency across user sessions and workflow executions.

According to various embodiments, the techniques and mechanisms described herein build on prior work related to data profiling, data planning, and data mapping. This earlier work is described in U.S. Patent App. No. 19/194,381 (Attorney Docket PRNVP002US) by Lloyd et al., filed April 30, 2025, titled “Data Integration Evaluation and Profiling in a Database System”, and in U.S. Patent App. No. 19/184,253 (Attorney Docket PRNVP001US) by Lloyd et al., filed April 21, 2025, titled “Data Integration Evaluation and Profiling in a Database System”, both of which are hereby incorporated by reference in their entirety and for all purposes.

In some embodiments, the disclosed technology improves the accuracy of AI-generated results by quantifying the reliability of data before it is used in generative or predictive modeling. By computing record-level, field-level, and segment-level reliability indicators, the system provides the AI model with a contextual understanding of data completeness, freshness, and distinctness. This structured quantification allows models to draw from trusted subsets of data, thereby reducing hallucinations and improving predictive integrity.

In one or more embodiments, automated field-level analysis enables real-time evaluation of data quality attributes such as default value usage or duplication rates. This automation eliminates the need for manual SQL queries or ad hoc quality audits that are typical in conventional systems. As a result, the technical latency associated with data verification is reduced, and reliability metrics can be refreshed dynamically in response to ongoing database updates.

In some implementations, hierarchically structured reliability indicators allow granular differentiation across multiple segments of the dataset. The segmentation process identifies geographic, temporal, or categorical variations in data reliability without requiring complete reprocessing of the dataset. This localized classification helps in isolating problem areas in near-real time, reducing computational load while preserving detailed visibility into data quality distributions.

According to various embodiments, the use of declarative logic and formula-based reliability computations allows seamless integration within existing database architectures. The formulas can compute composite reliability metrics based on field dependencies without altering the underlying schema. This technical structure allows reliability updates to propagate automatically whenever base records are modified, maintaining synchronized and current reliability scores without duplicative computation.

In one or more embodiments, the system improves throughput and scalability by distributing reliability assessments across hierarchical layers — record, field, and segment. Each layer can be recalculated independently, reducing redundant aggregation operations. This structure lowers computational complexity and conserves processing resources, thereby enabling scalable deployment across databases containing millions of records.

In some embodiments, continuous monitoring workflows ensure that reliability metrics remain valid in dynamic data environments. The workflow detects asynchronous updates and recalculates time-dependent indicators such as freshness or completeness. This real-time correction avoids transient inconsistencies caused by race conditions or delayed updates, improving data integrity for downstream AI inference and training operations.

According to various embodiments, visualizations such as histograms, trend graphs, and score distributions provide actionable insight into data reliability patterns. Displaying these metrics as structured visual outputs helps administrators quickly identify degradation or improvement trends. The technical advantage is a feedback loop that links reliability analysis directly with remediation workflows, enhancing the system’s responsiveness to data drift or deterioration.

In one or more embodiments, the integration of reliability indicators as persistent database fields enables interoperability with external modeling systems through existing APIs. This eliminates the need for intensive data preprocessing pipelines, as AI models can access cached reliability scores directly. By reducing the dependency on external validation scripts, the system enables faster and more consistent use of reliable data within AI workflows.

In some implementations, automatic segmentation and scoring allow predictive prioritization of data improvement efforts. The system computes confidence and hallucination risk metrics for specific dataset partitions, identifying segments that would yield the greatest impact if refined. This directed analysis replaces manual data remediation procedures with algorithmically guided selection, improving the efficiency of corrective processes.

According to various embodiments, these technical features collectively reduce error propagation from unreliable data into AI-generated outcomes. They create a structured mechanism to assess, track, and remediate data reliability at multiple levels of granularity, addressing major limitations of manual and static profiling systems. As a result, AI applications can operate reliably on continuously evolving data environments with improved performance stability and reduced computational overhead.

In some embodiments, the disclosed technology may provide measurable advantages for businesses that rely on data-driven decision-making. By enabling automated detection and scoring of unreliable data, organizations may reduce the financial and operational cost of data cleansing and reliability audits. Businesses may use these indicators to identify which data sources or departments require improvement. This targeted remediation lowers the effort needed to prepare datasets for AI deployment and accelerates the timeline for model validation and production release.

In one or more embodiments, the system allows organizations to maintain consistent AI performance through ongoing monitoring. Continuous updates to reliability indicators allow periodic tracking of trends across time or data segments. This capability helps businesses maintain compliance with internal accuracy standards or external regulatory obligations involving data governance. Automated monitoring reduces the risk of outdated information feeding into customer-facing AI systems, supporting more dependable decision-making across sales, marketing, or operations workflows.

In some implementations, the automation of reliability analysis provides time savings and efficiency gains for data management teams. Rather than conducting large, infrequent manual reviews, teams can use automated reliability metrics to perform focused interventions on data segments that impact key performance indicators. This shift from manual to automated evaluation decreases labor costs and limits disruption to live database operations. Furthermore, integration with existing customer relationship management and analytics tools enables seamless adoption without extensive retraining or restructuring.

According to various embodiments, improved data reliability translates directly into more trustworthy artificial intelligence and generative language model outputs. Systems that draw from verified, high-fidelity data produce fewer hallucinations and more accurate recommendations. This reliability improves user confidence in AI-generated insights, enhancing brand trust and customer satisfaction. Industries such as finance, healthcare, and retail may especially benefit from the reduced likelihood of misinformation or incorrect automated responses.

In one or more embodiments, the disclosed techniques may help businesses anticipate data degradation before it affects production systems. By observing reliability metrics such as data freshness, completeness, or distinct density, organizations may forecast when datasets will require maintenance. Preventive actions can then be prioritized to ensure continuity of AI-enabled functions. This predictive capability reduces operational downtime and contributes to a lower total cost of ownership for AI infrastructure.

In some implementations, large enterprises with distributed or multi-national data sources may use segmentation-based analysis to tailor data governance strategies by geography, line of business, or product line. The segmentation approach allows localized refinement without reprocessing entire datasets. This targeted control helps multinational organizations align with jurisdictional data quality standards while maintaining consistent global performance across AI applications.

According to various embodiments, societal benefits may arise from broader adoption of reliable AI data pipelines. When organizations use systems grounded in verifiable data reliability, the resulting AI outputs support more transparent and accurate public communications, analyses, or services. Continuous assessment of data quality strengthens accountability in AI decision-making and reduces the circulation of inaccurate or misleading information, benefiting both individual users and the wider community.

In some embodiments, individuals may benefit from more accurate automated interactions, such as customer support responses, personalized recommendations, or analytic summaries. Improved data reliability reduces exposure to errors or fabricated information in generative outputs. This leads to a more consistent and trustworthy user experience powered by AI technology that more closely reflects correct and current underlying facts.

### System Overview

According to various embodiments, techniques and mechanisms described herein provide for an automated solution to identifying reliable data for use in generative modeling applications such as agentic AI. Techniques and mechanisms described herein also provide for an automated solution to identifying data that may be unreliable and in need of improvement prior to use in such applications. This section provides an overview of such techniques and mechanisms in accordance with one or more embodiments.

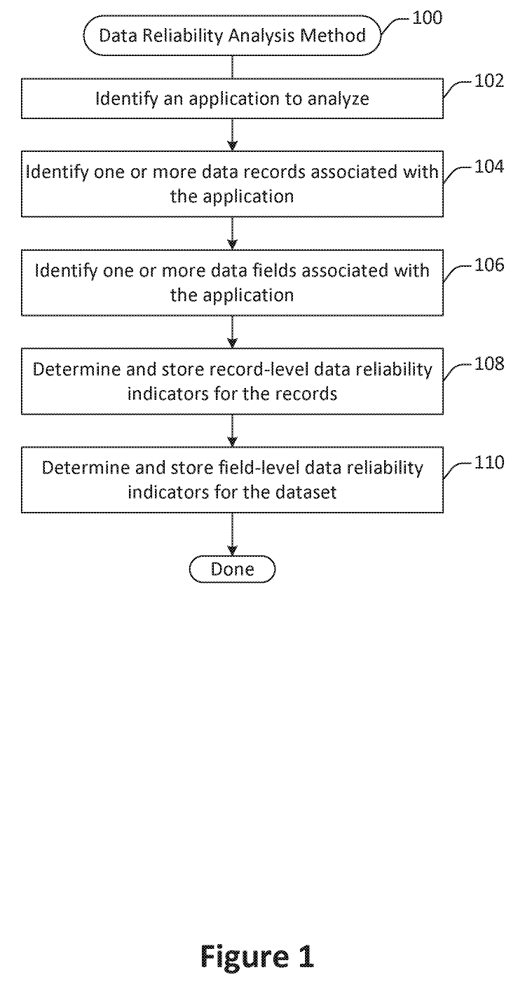

FIG. 1 illustrates a method 100 of performing a data reliability analysis, performed in accordance with one or more embodiments. The method 100 may be performed within a computing services environment providing access to a database system storing database records. The database records may be stored in association with various instances of one or more applications. For example, the database records may include customer relations management data accessible via one or more web applications.

An application to analyze is identified at 102. In some embodiments, the application may be an artificial intelligence or machine learning application implemented in a computing services environment. Such an application may include one or more generative, predictive, and/or classification elements.

One or more data records associated with the application are identified at 104. One or more data fields associated with the application are identified at 106. In some embodiments, one or more data records and/or data fields may be identified automatically, for instance based on application metadata. Alternatively, or additionally, such information may be determined based on user input.

A set of record-level data reliability indicators are determined and stored at 108. In some embodiments, record-level data reliability indicators may provide information as to the reliability of the data fields within an individual record for the application identified at 102.

A set of field-level data reliability indicators are determined and stored at 110. In some embodiments, the field-level data reliability indicators may provide information as to the reliability of the individual data fields identified at 106 at the level of the entire data set and/or at the level of segments of the data set. Additional details regarding the determination of field-level and record-level data reliability indicators are discussed in the following sections.

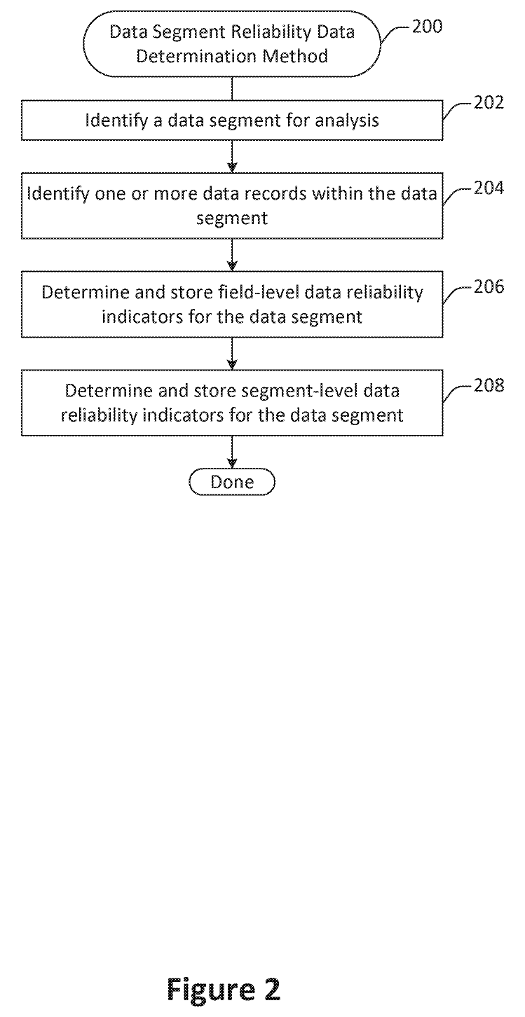

FIG. 2 illustrates a method 200 for determining data segment reliability data, performed in accordance with one or more embodiments. The method 200 may be used to determine field-level data reliability indicators within a data segment as well as cross-field segment-level data reliability indicators for the segment as a whole.

A data segment is identified for analysis at 202. In some embodiments, the data segment may be identified based on user input. For instance, a user may provide input indicating a request to analyze a specific portion of a data set such as the data records identified at 1904. Alternatively, or additionally, the data segment may be identified based on automated analysis. For instance, a data segment may be identified based on a segment score, discussed in further detail in relation to FIG. 2.

One or more data records within the data segment are identified at 204. In some embodiments, the one or more data records may be identified based on a database query of the database records, subset to the identified data segment.

Field-level data reliability indicators for the data segment are determined and stored at 206. In some embodiments, the field-level data reliability indicators may be the same as those discussed with respect to operation 1910. However, the values may be determined based only on those records that are included within the segment rather than the data set as a whole.

Segment-level data reliability indicators for the data segment are determined at 208. In some embodiments, the segment-level data reliability indicators may aggregate record-level indicators determined as discussed with respect to operation 1908 and field-level data reliability indicators at the segment level determined as discussed with respect to operation 206 to provide segment-level data reliability indicators specific to the application identified at 1902. For example, segment-level data reliability indicators may provide an estimated confidence level indicating an extent to which the application is reliable within the data segment. As another example, segment-level data reliability indicators may include an estimated hallucination risk indicating a probability that a generative language model associated with the application applied to the data segment will invent false information. Additional details regarding such indicators are discussed in the following section.

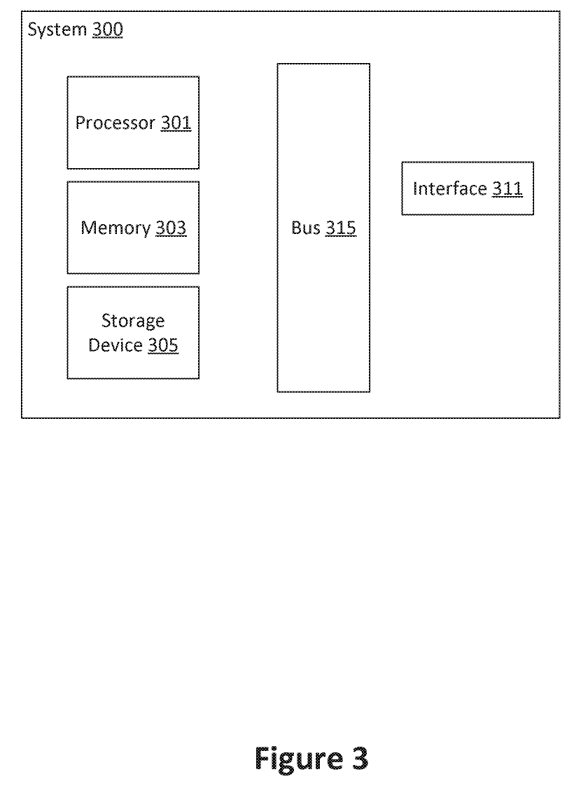

FIG. 3 illustrates one example of a computing device. According to various embodiments, a system 300 suitable for implementing embodiments described herein includes a processor 301, a memory module 303, a storage device 305, an interface 311, and a bus 315 (e.g., a PCI bus or other interconnection fabric.) System 300 may operate as variety of devices such as an application server, a database server, or any other device or service described herein. Although a particular configuration is described, a variety of alternative configurations are possible. The processor 301 may perform operations such as those described herein. Instructions for performing such operations may be embodied in the memory 303, on one or more non-transitory computer readable media, or on some other storage device. Various specially configured devices can also be used in place of or in addition to the processor 301. The interface 311 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

### Visual Examples

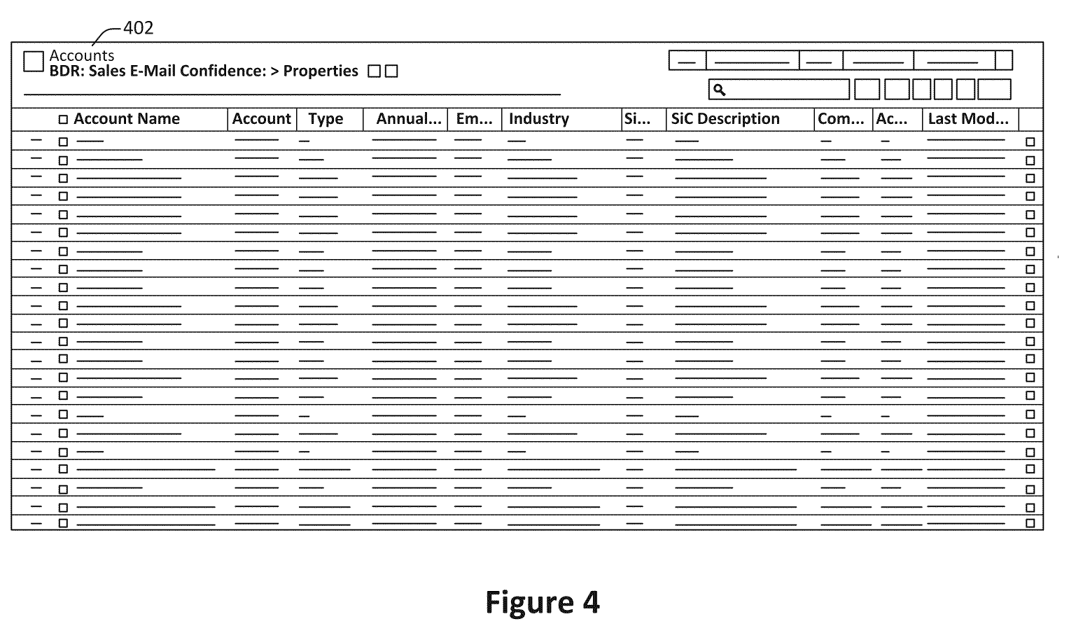

FIG. 4 through FIG. 15 illustrate user interfaces generated in accordance with one or more embodiments. These user interfaces provide an overview of a data reliability interaction processes. FIG. 4 illustrates a user interface 402 displaying a set of database records accessible via a database system. The database records correspond to accounts and include fields such as record type, revenue, industry, SIC code, SIC description, and more. In this example, the database includes many records and fields not shown in FIG. 4.

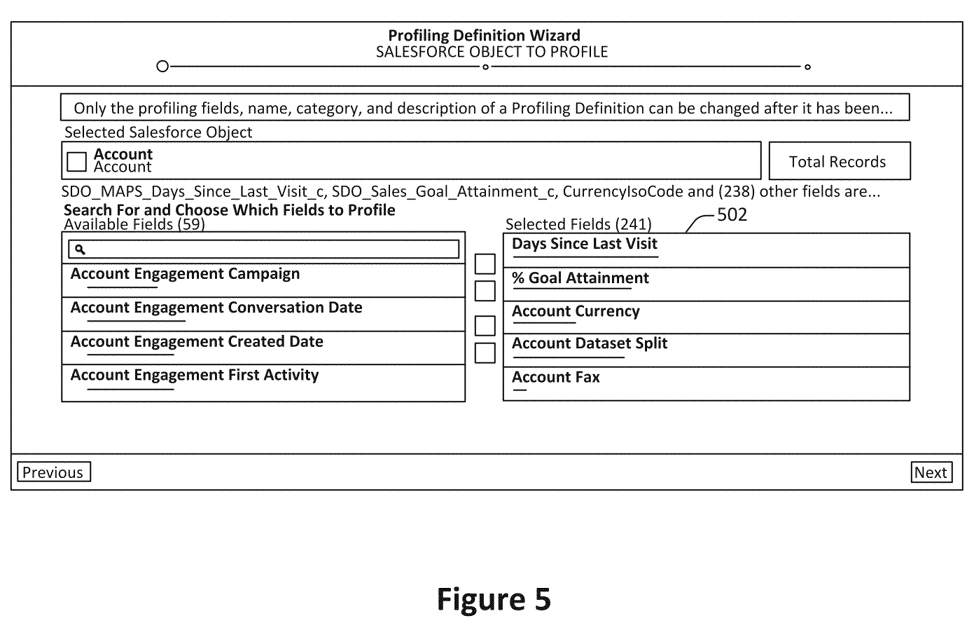

In FIG. 5, a profiling definition wizard allows selection of the fields at 502 to profile for a given database data set.

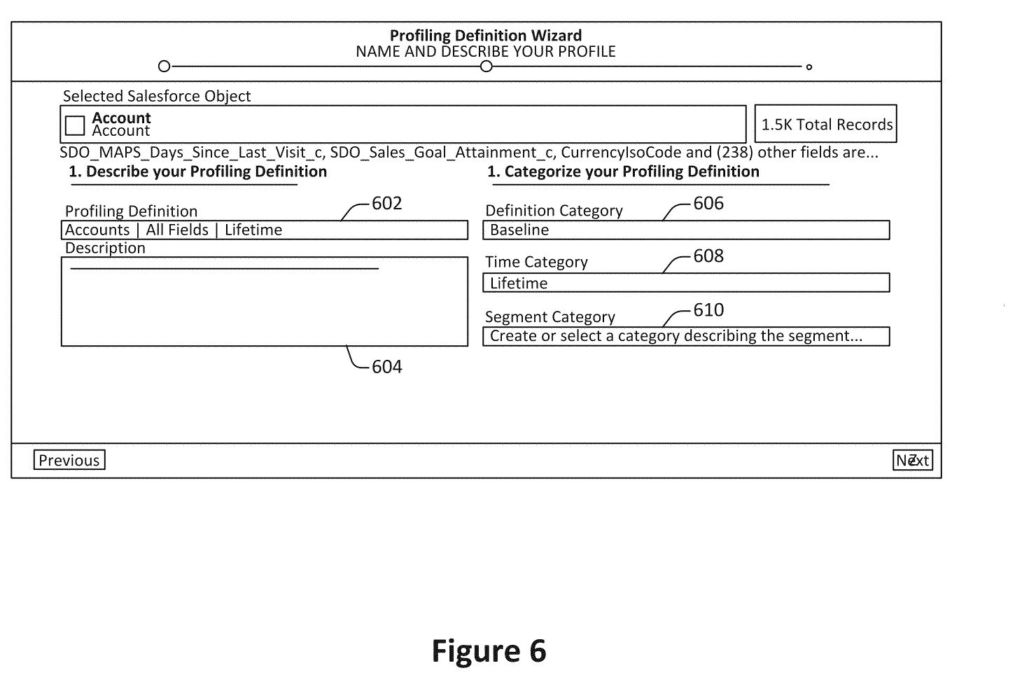

In FIG. 6, the profiling definition wizard allows for the profiling definition to be customized with a definition 602, a description 604, a definition category 606, a time category 608, and a segment category 610.

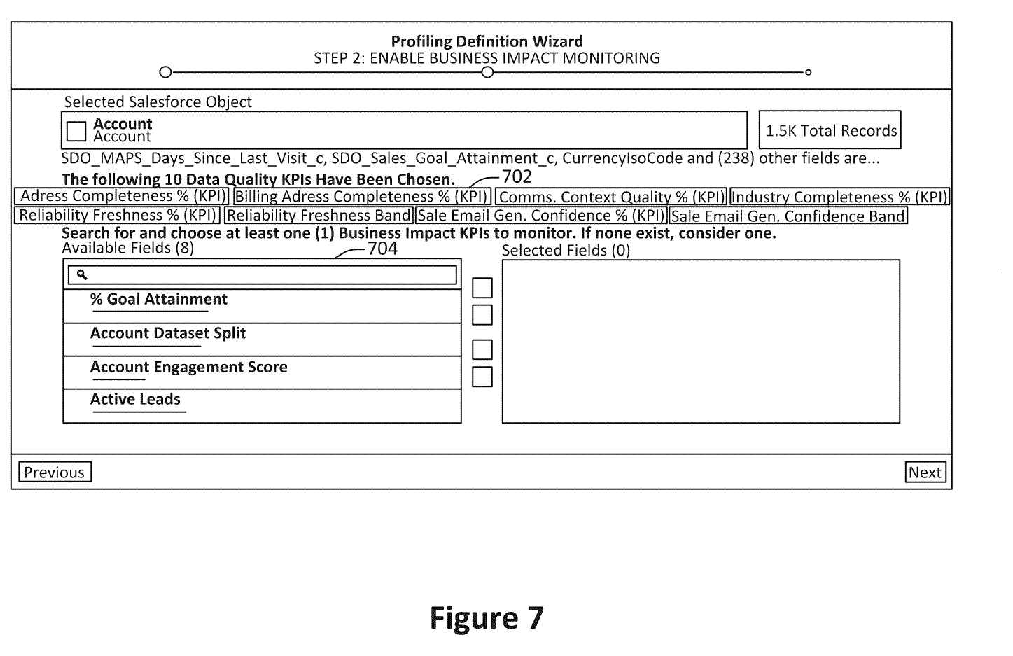

In FIG. 7, the profiling definition wizard allows for data quality KPIs 702 to be linked business impact KPIs 704. In this way, the relationship between data reliability and application outcomes may be modeled.

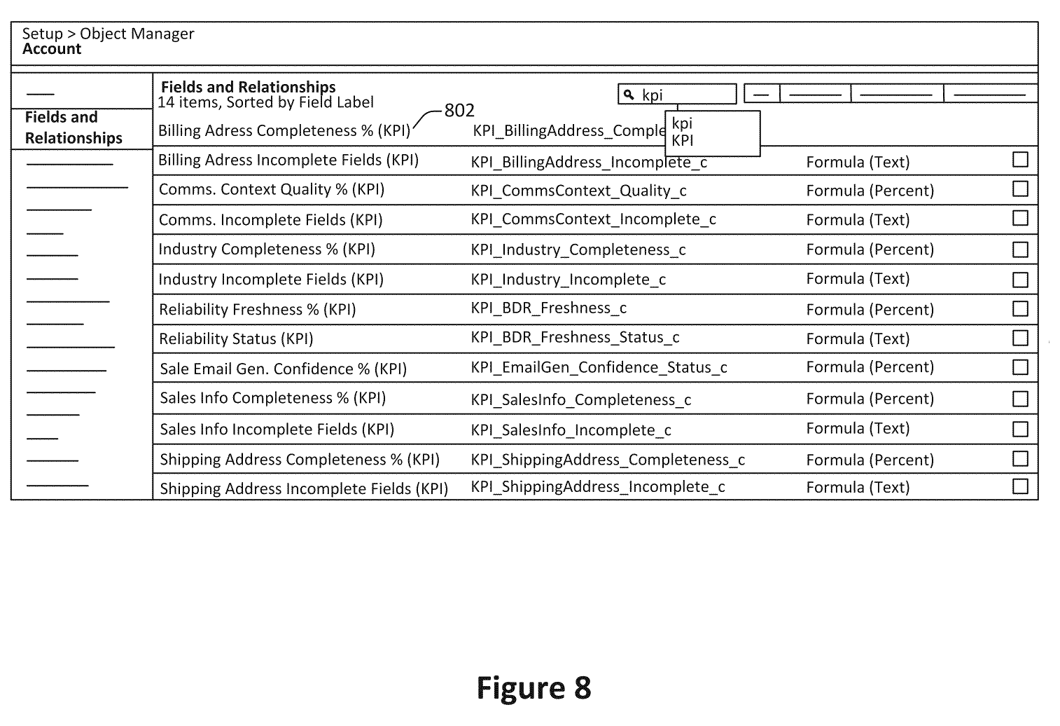

As shown in FIG. 8, metric values may be stored within the database system. For instance at 802, a set of formula fields may be stored in databases record to provide various types of reliability information, such as “Billing Address Completeness %”.

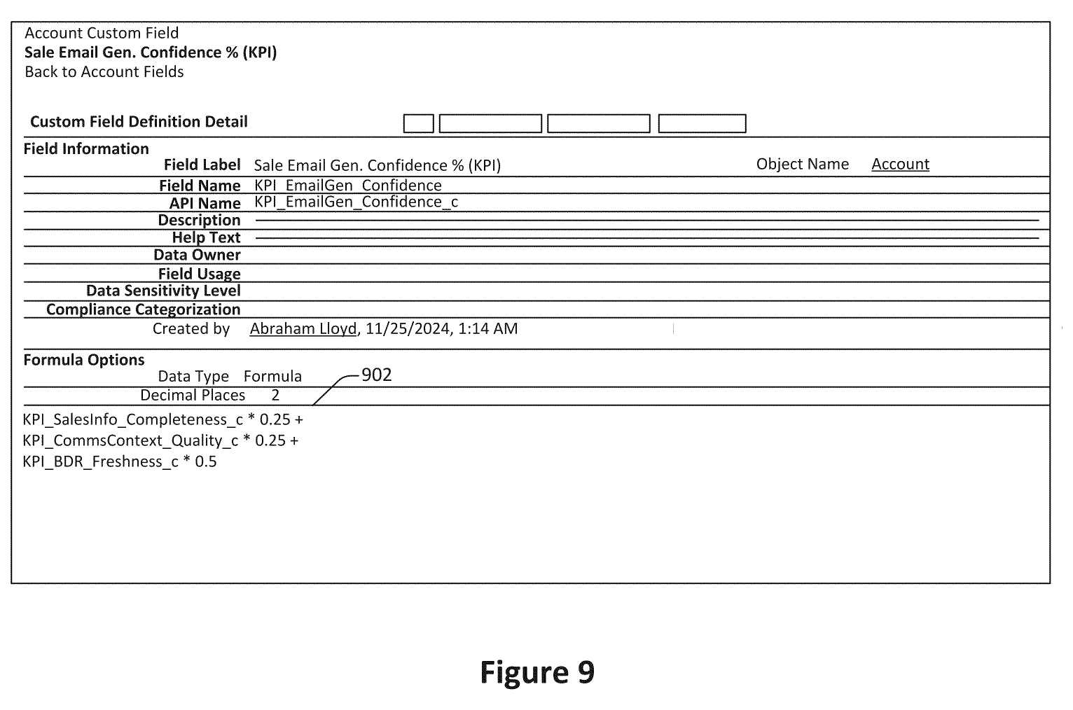

As shown in FIG. 9, one or more conditions may be specified at 902 to create a formula field. Such conditions may rely on other data reliability metrics, and may employ weighting so as to differentially weight different data reliability metrics. Conditions may be specified as a formula. For instance, the Sale Email Generative Confidence % KPI is defined as a weighted average of three other KPI values.

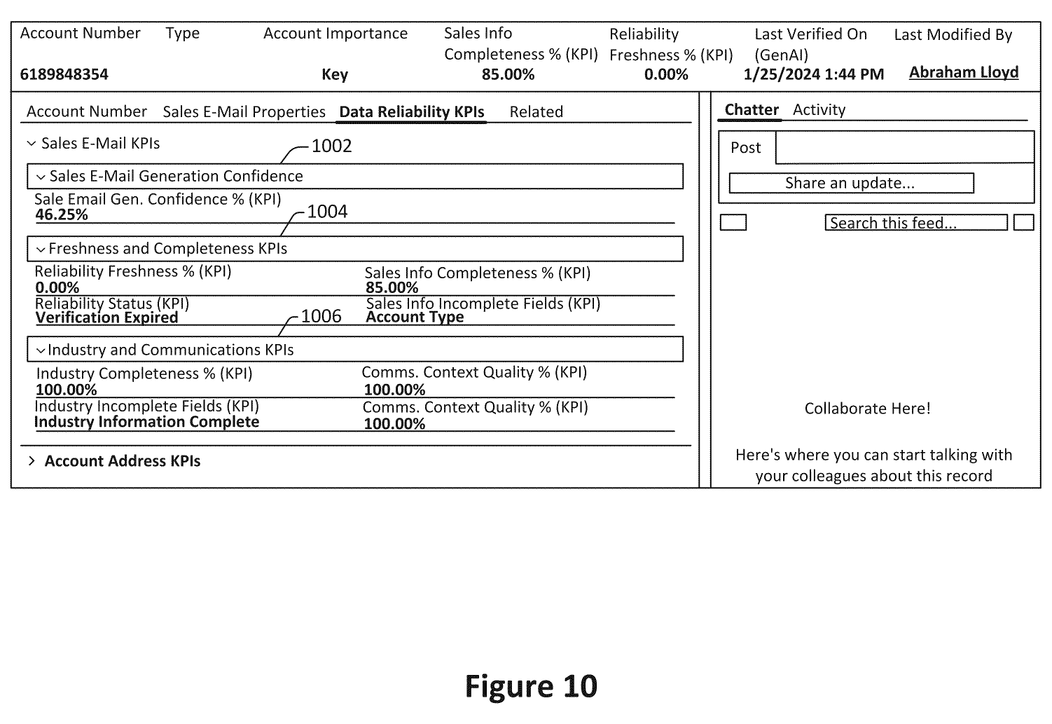

FIG. 10 illustrates various record-level data reliability indicators, organized into groups. For example, sales email generation confidence metrics are shown at 1002. As another example, various freshness and completeness indicators are shown at 1004. As yet another example, various industry and communication indicators are shown at 1006.

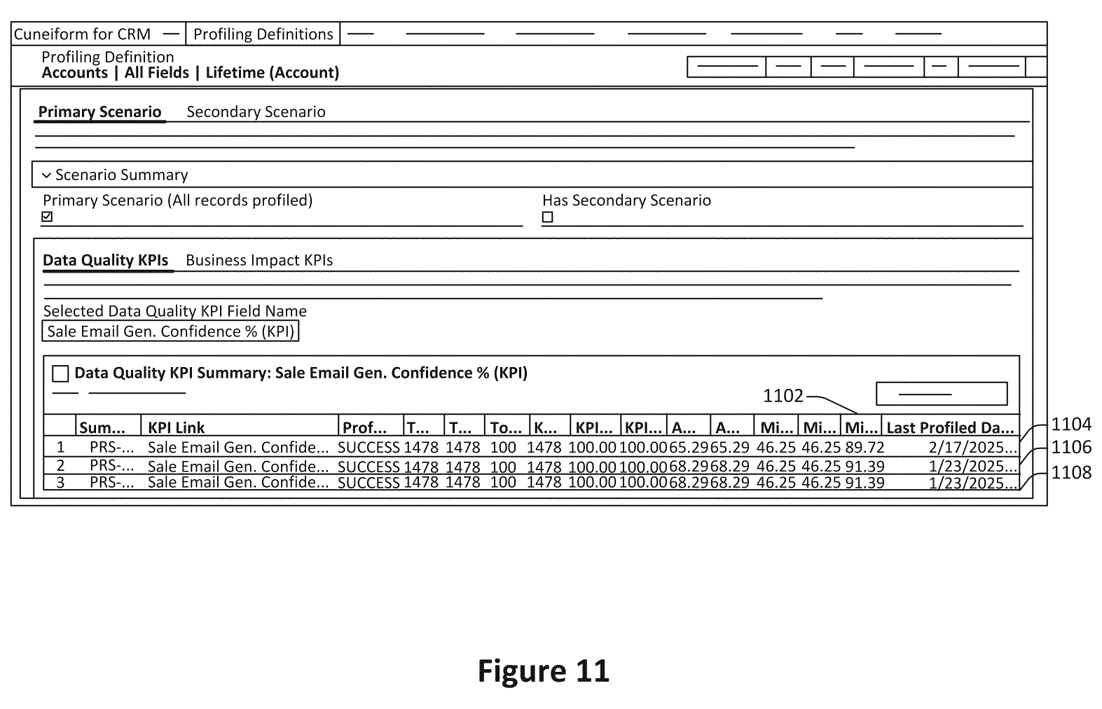

FIG. 11 illustrates how different instances of the same data reliability object may be determined. For instance, at 1102, the email confidence data reliability indicator value is decreasing over time due at 1104, 1106, and 1108 to decreasing data freshness.

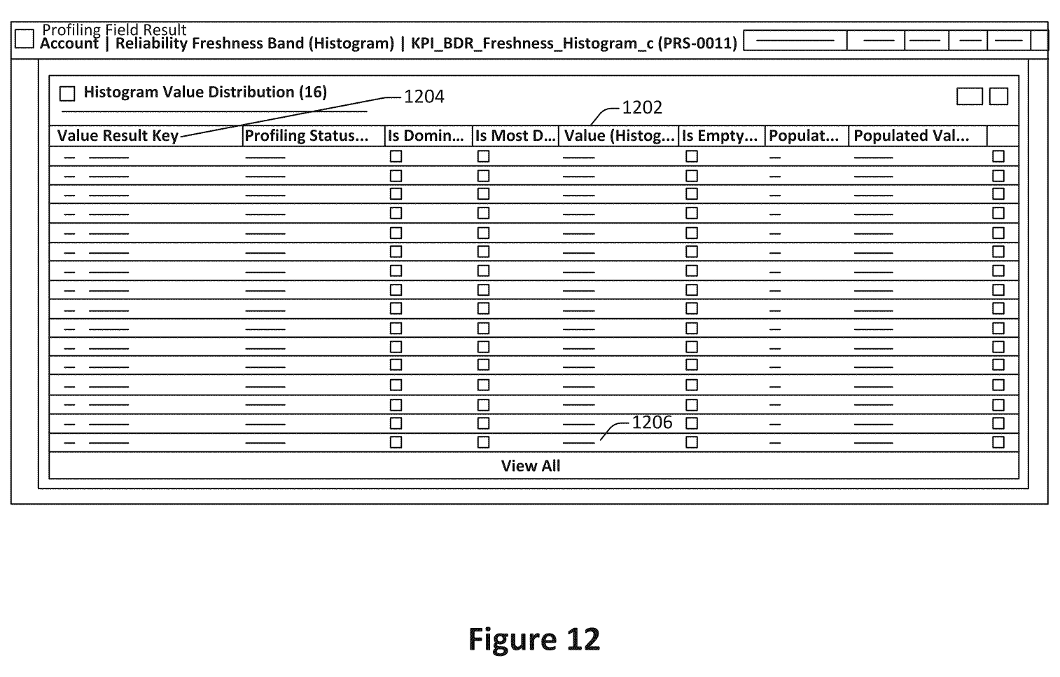

FIG. 12 shows data divided by freshness bands 1202. In FIG. 2, each value result key 1204 corresponds to a subset of data divided out by freshness band value group 1204. Such information may be used to identify how many records are associated with a band of a metric value, which in turn may be used to guide decisions about how to prioritize data reliability improvement efforts. For instance, data with a low reliability freshness band, such as the group 1206, may need to be evaluated for completeness.

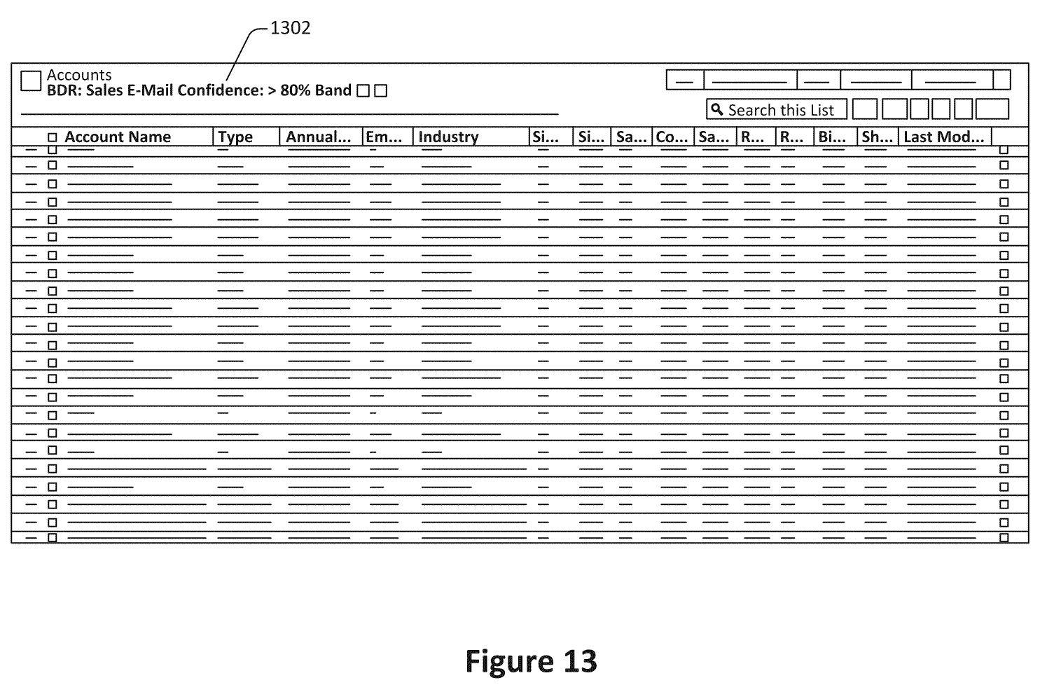

FIG. 13 shows data records selected based on metric value bands. For instance, at 1302, data records having a sales email confidence of greater than 80% have been selected. That is, the data records shown in FIG. 13 correspond to a single grouping as presented in FIG. 12.

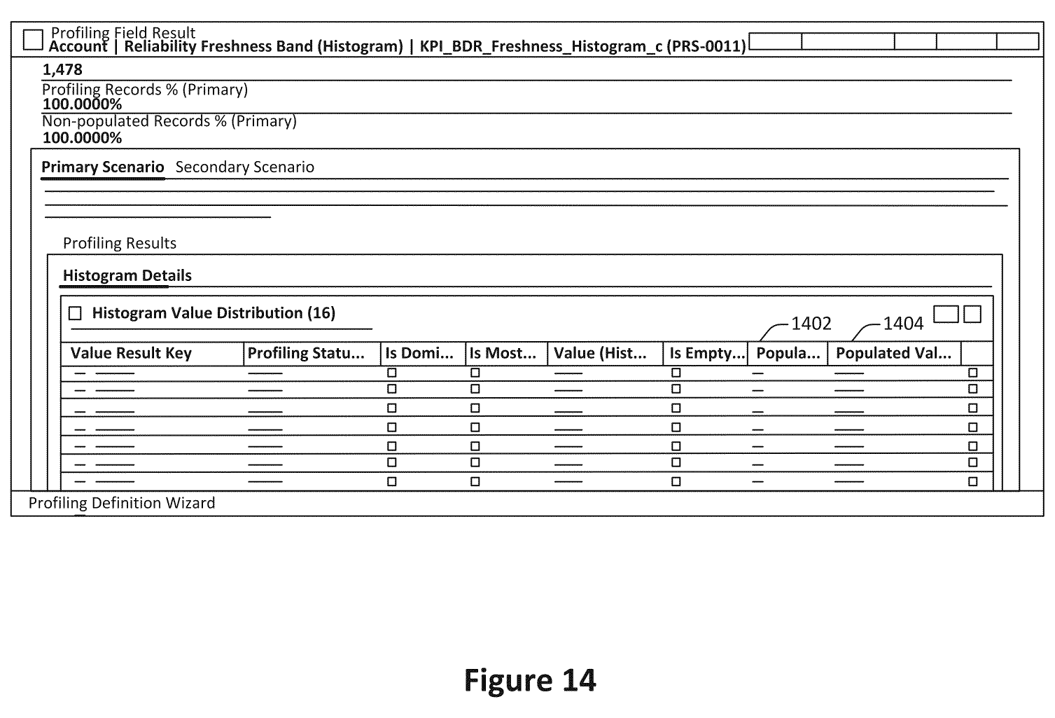

As shown in FIG. 14, different bands may be divided into segments, with information such as populated record count 1402 and reliability metrics 1404 displayed at the level of the band. The specific metric displayed at 1404 is the percent of populated values for the particular freshness band.

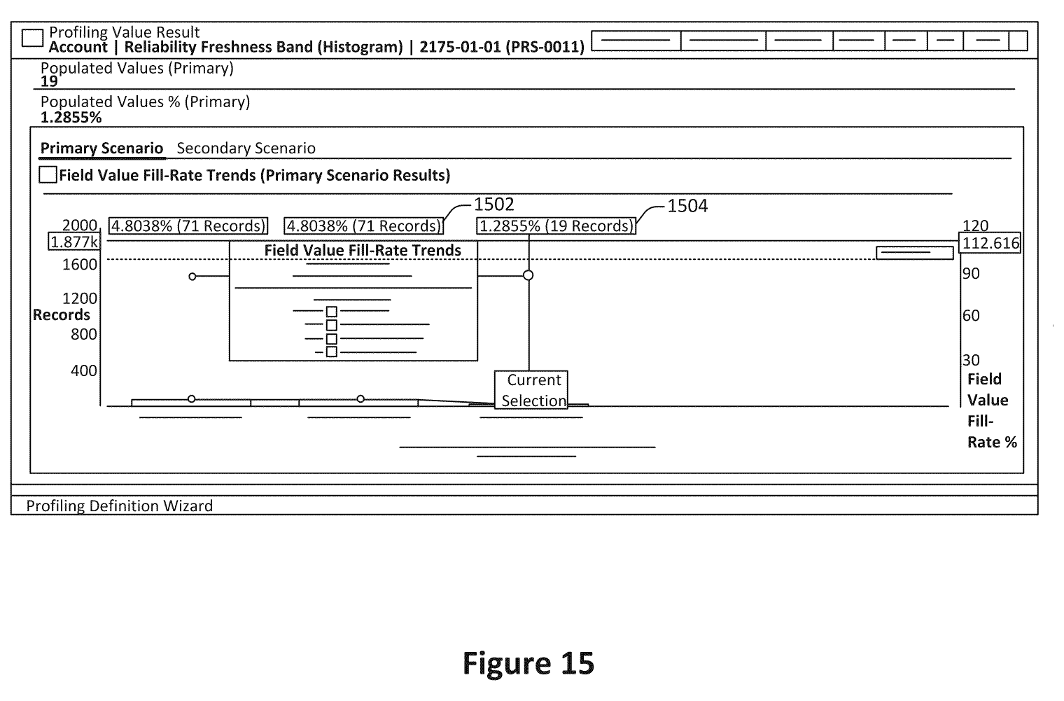

FIG. 15 shows a graph representing a change in the number of records in a band over time. Because data freshness is declining, the number of records in the band drops from 71 records at 1502 to 19 records at 1504.

### Additional Details

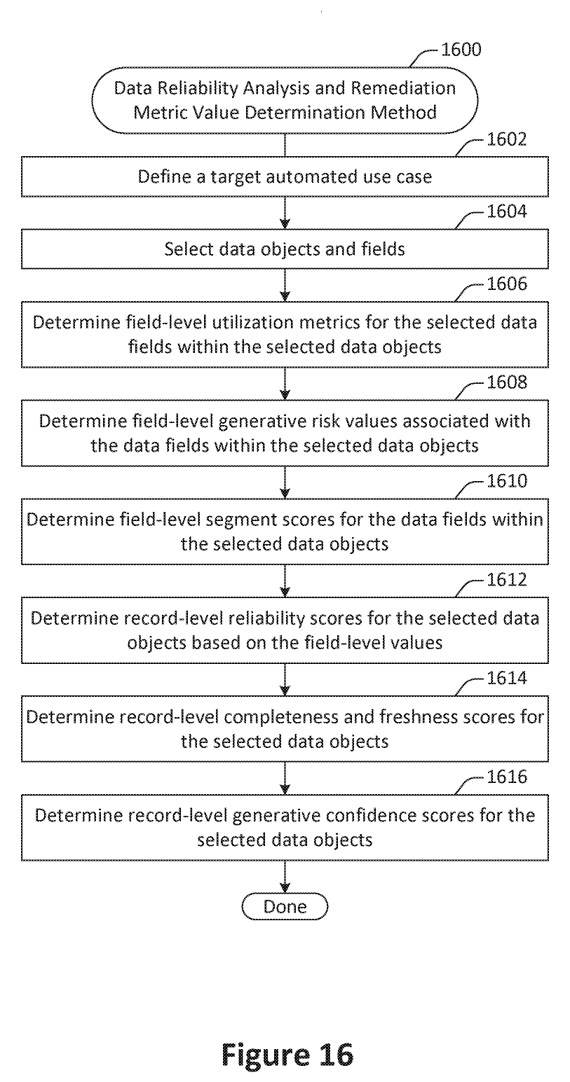

FIG. 16 illustrates a data reliability analysis and remediation method 1600, performed in accordance with one or more embodiments. The method 1600 may be performed at a computing services environment, for instance in an on-demand database system such as the platform provided by Salesforce. However, the techniques are broadly applicable to a range of computing services environments that include database systems storing data.

The method 1600 may be used to calculate data health and reliability insights for data associated with identified fields. The profile information is used to analyze data shape and health trends. Data quality indicators may be identified first at the data field level, then at the data record level, and finally at the data segment level.

At 1602, a use-case to analyze is identified. In some embodiments, such a use case may be identified based on user input. For instance, a user may identify a use case such as a particular agentic AI application associated with various elements such as data inputs, objectives, actions, and other processing operations.

At 1604, database objects and database fields to profile are identified. For instance, in an application to create sales emails, input data associated with database fields in account, contact, and opportunity objects may be needed. Within those objects, particular fields may be needed to determine generative language model outcomes.

In some embodiments, one or more database objects and/or database fields may be identified via user input. Alternatively, or additionally, one or more database objects and/or database fields may be identified automatically. For instance, the application identified at 1602 may be associated with various predetermined input fields associated with one or more predetermined database objects.

At 1606, field-level utilization metrics determined for the selected data objects. In some embodiments, such metrics may include analysis of utilization information of identified fields. Utilization information for a field may include elements such as: the field utilization percentage, the net utilization percentage, the distinct density percentage, the duplicate density percentage, the default value usage, the picklist value usage, and/or other types of information.

In some embodiments, various field indicators may provide low-level utilization information for a particular field within a data segment. For example, field utilization percentage may indicate a percentage of data objects in which the associated field has a non-empty value. As another example, net utilization percentage may recalculate field utilization percentage while excluding default values. That is, net utilization percentage may indicate a percentage of data objects in which the associated field has a non-empty and non-default value. As yet another example, distinct density percentage may count the number of distinct values stored in the associated field as a percentage of all data objects in the segment. As still another example, duplicate density percentage may indicate the percentage of data objects for which the field is storing a duplicate value. Such information can be determined, for instance, based on the number of distinct values. As still another example, default value usage may indicate a percentage of data objects in the segment where the field is set to the default field value. As still another example, picklist may indicate information such as a frequency with which a field implemented as a picklist has a stored value corresponding to the top and/or bottom item in the list.

At 1608, field-level generative risk values are determined for the selected data fields within the selected data objects. Generative risk values indicate the likelihood that fields can generate AI hallucinations and can be used in generative AI may be quantified. Various field indicators may provide intermediate level utilization information that is more directly informative of AI application readiness for the field. For example, hallucination risk may be determined based on low-level indicators such as field utilization and net utilization, since in the absence of information a generative language model may inject content and then generate text based on the injected content. As another example, data dictionary importance may provide information as to the importance of a field to a data dictionary. For instance, a field may be more or less important depending on whether it is a reference field, whether it represents a relationship, whether it is a picklist value, whether it is encrypted, the field type, the data type, whether data governance is configured, and/or whether the field is a select list or picklist. As yet another example, data dictionary completeness may indicate an extent to which information about the field, such as a field description, is included in the data dictionary.

At 1610, field-level segment scores are determined for the data fields within the selected data objects. In some embodiments, the segment score may provides a probability or other type of indicator identifying whether the field is suitable for subdividing the data objects into data segments For example, a picklist used to identify a region for an account may be used to subdivide a data set into segments, whereas contact information such as a street address may not be useful for segmentation. The segment score may be determined based on information such as the field utilization percentage, distinct density percentage, and other such low-level values.

In some embodiments, the segment score may be used to determine logical segmentation of the database data to refine the data reliability is analysis. Determining logical segmentation of the database data may involve, for instance, identifying logical subsets of the database data that systematically vary in terms of data reliability. For instance, the system may determine that data records created in the previous two years are relatively reliable, but older database records are relatively unreliable. Such information may then be used to identify data segments to target for improvement.

According to various embodiments, segments may be identified automatically and/or based on user input. The particular segments identified may depend on how a user would like to prioritize the data. For example, a user and/or the system may select one or more dimensions such as year, record type, performance level, industry, or revenue for use in segmenting the data.

At 1612, formula fields and declarative features in a database system may be used to measure data reliability for individual data objects.

At 1614, one or more aggregated completeness and/or freshness scores are determined at the level of an individual data record. Any of various types of aggregated information may be determined. For example, contact information completeness may aggregate information such as whether a record has a primary contact and whether the primary contact is associated with an email address that has been verified within the last year. As another example, sales information completeness may aggregate information such as whether the account is active, an importance level for the account, a region for the account, a revenue level for the account, and/or other such metrics. As yet another example, industry completeness may aggregate information such as whether industry information for the account is present, whether an SIC code is correct, whether the industry information is congruent, and/or other such metrics. As still another example, freshness may aggregate information such as whether the account has been updated within the last 90 days, whether the account has submitted a support ticket, whether the account has made a purchase in the last month, and/or other such metrics. Such indicators may be defined by one or more formulas, which may be determined automatically or which may be user-specified.

At 1616, record-level application data reliability values may be determined. For example, a sales email confidence percentage may indicate an estimated percentage that the generative language model application can reliably generate a sales email based on the available data. As another example, an email hallucination percentage may indicate an estimated percentage that the sales email will include falsified information generated by the generative language model.

In some embodiments, record-level application data reliability values may be determined based on more granular record-level values such as contact information completeness, industry completeness, sales information freshness, and sales information completeness determined as discussed with respect to operation 306. Such values may be used, for instance, to restrict applications to being used with records having sufficient data reliability. For instance, email formulation may be restricted to records having a confidence score above 75% and a hallucination risk at less than 7%.

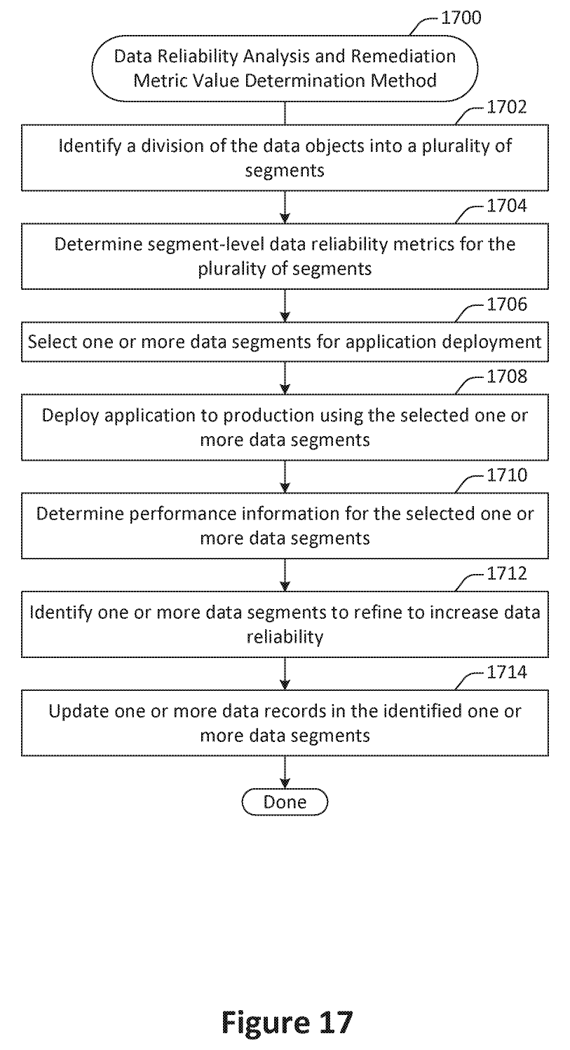

FIG. 17 illustrates a data segment selection method 1700, performed in accordance with one or more embodiments. The method 1700 may be used to process and apply the field-level and object-level metrics determined in the method 1600 for the purpose of selecting one or more segments of data for application deployment.

At 1702, a division of the data objects into a plurality of segments is identified. In some embodiments, the division may be based on information such as the segment scores and/or the record-level application data reliability values. For example, the record-level application data reliability values may be used to divide the data objects into segments based on reliability value bands (e.g., greater than 80%, 60%-80%, etc). As another example, the segment scores may be used to group the data objects into logical units (e.g., geographically) that internally exhibit similar data reliability values (e.g., 25% sales email confidence and 85% email hallucination risk for records associated a North area, and 95% sales email confidence and 7% hallucination risk for records associated with a South area). Such divisions may be created automatically and/or based on user input.

At 1704, the database objects and database field data are re-analyzed using data reliability indicators to measure the readiness of different segments. For example, the system may determine that accounts in the northern geographic region are not ready for such usage due to having a low confidence score of 25% and a high hallucination risk of 85%, while accounts in the southern geographic region are ready for generative AI applications due to having a confidence score of 95% and a hallucination risk of 7%.

At 1706, segments are selected based on the segment-level reliability metrics. In some embodiments, the most reliable segment of the data may be identified for powering generative modeling deployments. In the above example, the South area records may be selected, while the North area records are identified for additional processing before being deployed to the selected application.

At 1708, the application is deployed to production using the selected one or more data segments. Deploying the application to production may mean, for instance, activating the application for use with the identified set of data records included in the selected segments.

At 1710, performance information for the selected one or more data segments is determined. In some embodiments, a set schedule may be assigned to a workflow. Such a workflow may then periodically re-evaluate data reliability values for the identified database data segments. Such monitoring may include any of a variety of operations.

At 1712, prioritization information for which data segments to refine to increase their data reliability may be identified. For instance, data segments that are both desirable for generative modeling and of low reliability may be selected for improvement.

At 1714, one or more data records in the identified data segments are updated to improve reliability. Such an approach may allow for generative modeling to be deployed for a larger number of database data segments and/or improved for the existing data segments.

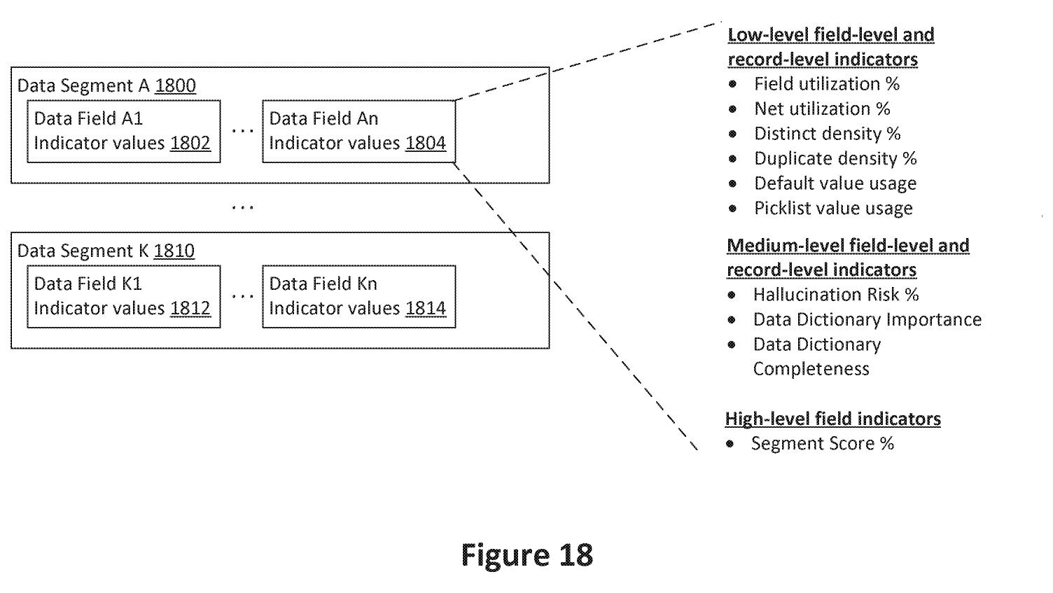

FIG. 18 illustrates a block diagram of data field indicators within a set of data segments, configured in accordance with one or more embodiments.

As shown in FIG. 18, a database data set may include multiple data segments such as the data segment A 1800 through the data segment K 1810. Each data segment may include some number of fields, such as the fields A1 through An and K1 through Kn. Corresponding sets of indicator values may be determined for each data field within each data segment. Additional indicator values may be determined for groups of fields (e.g., contact-level metrics for a group of contact-related fields).

In some embodiments, as discussed herein, record-level metric values may be determined on the data record level. Additionally, one or more segment-level indicators may provide an overall estimate of the field’s readiness in AI applications.

According to various embodiments, as shown in FIG. 18 and as discussed generally herein, a variety of different metric values may be determined. For example, high-level segment-level data reliability metrics may be determine. As another example, intermediate-level data reliability metrics may be determined for individual data records within data segments. As yet another example, low-level data reliability metrics may be determined for individual data fields or groups of data fields. Additionally, some data reliability metrics may be defined as formulae based on other data reliability metrics. For instance, segment-level metrics may aggregate data record-level and data field-level metrics.

According to various embodiments, the operations and analysis discussed herein may be used to quickly identify opportunities for data improvement. For example, a data segment with a high revenue potential but insufficient data quality may be readily identified for data quality improvement, allowing efforts to be focused on the data record types, data record fields, and data record segments having the highest expected impact.

In some embodiments, the system further includes a reliability weighting engine configured to dynamically adjust the relative contribution of individual field-level indicators to record-level and segment-level reliability scores based on observed downstream application performance. For example, if a predictive or generative AI application demonstrates heightened sensitivity to inaccuracies in a particular field, the weighting engine may increase the contribution of completeness, freshness, or distinct density indicators associated with that field when computing composite confidence or hallucination risk metrics. Such adaptive weighting may be performed automatically based on monitored application outcomes, thereby forming a closed-loop optimization process between data reliability assessment and application performance.

In one or more embodiments, the system may employ machine learning techniques to model relationships between historical data reliability indicators and measured application outputs. A training process may correlate prior reliability vectors with observed error rates, hallucination frequencies, user correction events, or other performance indicators. Based on such correlations, the system may generate a predictive reliability model capable of estimating an expected application performance metric prior to deployment. This predictive capability allows the system to simulate the impact of proposed data remediation efforts on AI application readiness without requiring full production deployment.

In some implementations, reliability indicators may be computed incrementally using change-data-capture mechanisms or event-driven triggers within the database system. Rather than recalculating reliability metrics across an entire dataset, the system may identify modified records and selectively recompute only those field-level and record-level indicators affected by the changes. Segment-level aggregates may be updated through differential aggregation techniques that adjust prior stored values based on deltas. This incremental computation architecture reduces processing overhead and enables near real-time reliability updates in high-throughput database environments.

According to various embodiments, the system may maintain a reliability lineage structure that records dependencies among low-level indicators, intermediate indicators, and composite metrics. The lineage structure may identify which base data fields contribute to each generative confidence score, hallucination risk value, or segment-level reliability metric. Such traceability enables explainability of reliability determinations, allowing administrators to identify the precise data attributes responsible for a low confidence score or elevated hallucination risk. This structured dependency mapping further supports auditability and compliance requirements in regulated industries.

In one or more embodiments, the system may enforce application gating policies based on reliability thresholds defined at the field, record, or segment level. For example, prior to invoking a generative model, an execution controller may evaluate a stored confidence score and compare it to a configurable minimum threshold. If the threshold is not satisfied, the controller may restrict execution, substitute a fallback workflow, request human review, or initiate automated remediation procedures. Such gating mechanisms provide a technical safeguard that prevents unreliable data from propagating into automated decision pipelines.

In some embodiments, the system may support cross-application reliability normalization, enabling reliability metrics computed for different applications to be expressed on a common scale. Because different AI use cases may require distinct field subsets or weighting schemes, raw reliability scores may not be directly comparable. A normalization layer may transform application-specific reliability vectors into standardized confidence indices, facilitating portfolio-level monitoring across multiple AI deployments within an enterprise environment.

In various embodiments, remediation operations may be prioritized based on an expected marginal improvement in application-level reliability. The system may compute a remediation impact score for candidate fields or segments by estimating the projected increase in generative confidence or reduction in hallucination risk resulting from specific corrective actions. Remediation tasks may then be ranked according to impact score, revenue potential, or strategic importance. This prioritization mechanism allows computational resources and human effort to be directed toward interventions with the greatest projected technical effect.

In some implementations, the system may integrate reliability indicators directly into prompts or context windows provided to generative language models. For example, reliability metadata may be appended to structured input data to inform the model of relative certainty levels associated with individual attributes. A model may be configured to adjust output verbosity, hedging language, or citation behavior in response to these reliability indicators. By embedding structured reliability context into the generative process itself, the system further reduces the probability of unsupported inference and improves transparency of AI-generated outputs.

According to various embodiments, the disclosed techniques may be applied to both structured and semi-structured data sources. For semi-structured data, such as free-text notes or document fields, reliability indicators may include measures of semantic consistency, extraction confidence from upstream natural language processing pipelines, or recency of content validation. These additional indicators may be incorporated into the same hierarchical framework used for structured fields, thereby extending reliability analysis across heterogeneous data modalities.

In one or more embodiments, reliability metrics may be versioned over time, with each analysis cycle generating a snapshot identifier associated with stored indicator values. Versioning enables historical comparison of reliability states, rollback analysis, and evaluation of remediation effectiveness across time intervals. Such temporal version control further supports trend analysis, forecasting of degradation patterns, and objective measurement of data governance initiatives.

In some embodiments, the system may compute a multi-dimensional reliability vector for each record, the vector comprising a plurality of normalized component scores corresponding to completeness, freshness, consistency, utilization, generative risk, and contextual sufficiency. Rather than collapsing these dimensions into a single scalar value at all times, the vector may be preserved in structured form and stored in association with the corresponding database record. Downstream applications may selectively consume one or more dimensions of the vector depending on the operational context. For example, a classification model may rely more heavily on completeness and distinct density, whereas a generative model may rely more heavily on hallucination risk and contextual sufficiency. This vectorized architecture enables fine-grained reliability-aware processing without requiring recomputation of base indicators.

In one or more embodiments, cross-field consistency analysis may be performed to identify logical contradictions or implausible combinations of field values. For example, the system may determine whether a revenue value is inconsistent with an associated company size field, whether a geographic region is incompatible with a postal code prefix, or whether a date field conflicts with a related status indicator. Such cross-field constraints may be defined declaratively or derived from historical data distributions. Violations may reduce a record-level reliability score or increase a generative risk metric. This cross-field analysis introduces semantic validation beyond simple field-level completeness checks.

In some implementations, the system may incorporate statistical anomaly detection techniques to identify outlier records within a segment. Statistical baselines may be computed for numeric or categorical fields within each segment, and records deviating beyond a threshold may be flagged. These anomaly indicators may be incorporated into segment-level reliability metrics or used to trigger remediation workflows. Because anomalous records may disproportionately influence predictive models or generative outputs, isolating such records prior to AI processing improves stability and reduces error propagation.

According to various embodiments, the system may support hierarchical segmentation in which segments are nested within broader segments. For example, records may first be segmented by geography, then by industry within geography, and then by time period within industry. Reliability metrics may be computed at each hierarchical level. This hierarchical segmentation allows identification of localized reliability degradation that may not be visible at higher aggregation levels. It also enables selective deployment of AI applications at the most granular level meeting predefined reliability thresholds.

In one or more embodiments, reliability scores may be adjusted based on data provenance metadata. For example, fields originating from verified third-party integrations may be assigned a higher baseline trust factor than fields entered manually. Similarly, data derived from automated enrichment pipelines with known accuracy rates may be weighted differently than user-supplied free-text entries. The system may store provenance attributes for each field and incorporate these attributes into field-level generative risk calculations. This provenance-aware reliability modeling further differentiates reliable structured inputs from uncertain or weakly validated sources.

In some embodiments, the system may compute a contextual sufficiency metric representing whether a record contains the minimum required combination of attributes necessary for a designated AI use case. Unlike raw completeness percentages, contextual sufficiency may evaluate the presence of specific interdependent field groups. For instance, a sales email generation use case may require at least one verified contact method, an industry classification, and a recent engagement indicator. Absence of any mandatory component may reduce contextual sufficiency below an activation threshold even if overall completeness remains high. This targeted evaluation aligns reliability analysis directly with operational requirements.

In various implementations, reliability degradation forecasting may be performed using temporal trend analysis. By maintaining historical versions of reliability indicators, the system may fit time-series models to predict when segment-level freshness or completeness is likely to fall below acceptable thresholds. Forecasted degradation may trigger proactive remediation tasks, data refresh workflows, or scheduled validation checks. This predictive monitoring reduces the likelihood that AI systems operate on silently deteriorating data conditions.

In one or more embodiments, the system may expose reliability indicators through an application programming interface (API) that supports query filtering based on reliability criteria. For example, an external AI service may request only those records with a generative confidence score above a specified value and a hallucination risk below another specified value. The API layer may enforce these constraints server-side, ensuring that unreliable records are excluded prior to model invocation. Such integration minimizes the need for duplicative reliability filtering logic in downstream services.

In some implementations, reliability indicators may be incorporated into access control policies. For example, certain automated workflows may be permitted to access or act upon only high-confidence records, while lower-confidence records may require elevated permissions or supervisory review. Reliability-aware access control provides an additional technical safeguard against automated decisions based on uncertain data.

According to various embodiments, remediation workflows may include automated enrichment or correction mechanisms. For instance, if a field exhibits high duplicate density, the system may invoke a deduplication service. If freshness falls below a defined interval, automated outreach workflows may request updated information. If data dictionary completeness is low, administrative prompts may be generated to populate missing metadata descriptions. These remediation actions may be logged and associated with subsequent improvements in reliability indicators, enabling quantification of remediation effectiveness.

In one or more embodiments, the system may compute an uncertainty propagation metric estimating how uncertainty at the field level affects downstream generative or predictive outcomes. For example, the system may model how a 10% reduction in field completeness translates into an expected increase in hallucination probability. Such propagation modeling may be derived empirically from historical performance data. By explicitly modeling uncertainty flow, the system provides a quantitative basis for prioritizing specific field improvements.

In some embodiments, reliability metrics may be used to adjust training data selection for machine learning models. During training or fine-tuning, records with reliability scores below a threshold may be excluded or down-weighted to reduce the influence of noisy or incomplete data. Similarly, generative model fine-tuning may prioritize high-confidence records to improve factual grounding. Integrating reliability directly into training pipelines enhances model robustness without requiring manual dataset curation.

In various implementations, the system may support multi-tenant isolation of reliability metrics within shared database infrastructures. Each tenant may maintain independent reliability definitions, thresholds, and weighting schemes while leveraging a common computational framework. This architecture enables scalability across enterprise environments where different business units or clients have distinct AI use cases and data governance requirements.

In one or more embodiments, the system may generate audit reports summarizing reliability metrics, remediation activities, threshold policies, and trend analyses over defined intervals. Such reports may be stored in a structured format suitable for compliance documentation. The presence of stored reliability indicators and lineage mappings supports defensible explanations of AI readiness decisions and deployment gating actions.

In some implementations, reliability evaluation may extend to derived or computed fields used as model features. When a feature is calculated from multiple base fields, the system may determine a composite feature reliability based on the reliabilities of its inputs. If any contributing field falls below a threshold, the derived feature reliability may be proportionally reduced. This ensures that higher-level abstractions inherit the uncertainty of their constituent data elements.

According to various embodiments, the system may maintain separate reliability profiles for different AI task categories, such as generative communication, classification, recommendation, or forecasting. Because task requirements vary, a dataset segment deemed suitable for one category may not satisfy thresholds for another. Maintaining task-specific reliability profiles avoids overgeneralization and ensures that deployment decisions are tailored to the operational characteristics of each AI workload.

### Conclusion

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. Particular embodiments may be implemented without some or all of the specific details described herein. In other instances, well known process operations have not been described in detail in order not to unnecessarily obscure the present invention. Accordingly, the breadth and scope of the present application should not be limited by any of the implementations described herein, but should be defined only in accordance with the claims and their equivalents.

1. A system comprising:
at least one processor;
a memory storing executable instructions; and
a database system storing structured data records, wherein execution of the instructions by the at least one processor causes the system to:
identify a designated artificial intelligence application configured to use data stored in the database system;
identify a plurality of database fields associated with the designated artificial intelligence application;
for each of the plurality of database fields, determine: (i) a field utilization percentage, (ii) a distinct value density percentage, and (iii) a freshness value based on update timing associated with the field;
determine, for each of the plurality of database fields, a generative risk value based at least in part on the field utilization percentage and the freshness value;
for each structured data record, determine a record-level reliability score based on one or more of: (i) the generative risk values of fields included in the structured data record, (ii) a completeness value associated with the structured data record, and (iii) a freshness value associated with the structured data record;
divide the structured data records into a plurality of data segments;
for each of the plurality of data segments, determine a segment-level reliability metric based on an aggregation of record-level reliability scores for structured data records included in the data segment;
store the generative risk values, the record-level reliability scores, and the segment-level reliability metrics as data reliability indicators within the database system; and
control execution of the designated artificial intelligence application based on the segment-level reliability metric.

2. The system of claim 1, wherein the field utilization percentage represents a percentage of structured data records in which a field contains a non-empty value.

3. The system of claim 1, wherein the distinct value density percentage represents a number of distinct values stored in a field divided by a total number of structured data records or non-empty values.

4. The system of claim 1, wherein determining the generative risk value comprises applying a weighted aggregation of multiple field-level reliability metrics.

5. The system of claim 1, wherein the record-level reliability score comprises a weighted combination of:
(i) a contact information completeness value,
(ii) a sales information completeness value, and
(iii) a freshness value.

6. The system of claim 1, wherein dividing the structured data records into the plurality of data segments comprises grouping the structured data records based on at least one of: (i) a geographic attribute, (ii) a record type, (iii) a creation date, and (iv) a reliability value band.

7. The system of claim 1, wherein controlling execution of the designated artificial intelligence application comprises restricting use of the artificial intelligence application to data segments having segment-level reliability metrics that satisfy a predefined threshold.

8. The system of claim 1, wherein controlling execution of the designated artificial intelligence application comprises preventing execution of the artificial intelligence application for structured data records having record-level reliability scores below a predefined threshold.

9. The system of claim 1, wherein the artificial intelligence application comprises a generative language model configured to generate text based on structured data stored in the database system.

10. A computer-implemented method performed by at least one processor in communication with a database system storing structured data records, the method comprising:
identifying a designated artificial intelligence application configured to use data stored in the database system;
identifying a plurality of database fields associated with the designated artificial intelligence application;
for each of the plurality of database fields, determining:
(i) a field utilization percentage,
(ii) a distinct value density percentage, and
(iii) a freshness value based on update timing associated with the field;
determining, for each of the plurality of database fields, a generative risk value based at least in part on the field utilization percentage and the freshness value;
for each structured data record, determining a record-level reliability score based on one or more of:
(i) the generative risk values of fields included in the structured data record,
(ii) a completeness value associated with the structured data record, and
(iii) a freshness value associated with the structured data record;
dividing the structured data records into a plurality of data segments;
for each of the plurality of data segments, determining a segment-level reliability metric based on an aggregation of record-level reliability scores for structured data records included in the data segment;
storing the generative risk values, the record-level reliability scores, and the segment-level reliability metrics as data reliability indicators within the database system; and
controlling execution of the designated artificial intelligence application based on the segment-level reliability metric.

11. The method of claim 10, wherein the field utilization percentage represents a percentage of structured data records in which a field contains a non-empty value.

12. The method of claim 10, wherein the distinct value density percentage represents a number of distinct values stored in a field divided by a total number of structured data records or non-empty values.

13. The method of claim 10, wherein determining the generative risk value comprises applying a weighted aggregation of multiple field-level reliability metrics.

14. The method of claim 10, wherein the record-level reliability score comprises a weighted combination of:
(i) a contact information completeness value,
(ii) a sales information completeness value, and
(iii) a freshness value.

15. The method of claim 10, wherein dividing the structured data records into the plurality of data segments comprises grouping the structured data records based on at least one of:
(i) a geographic attribute,
(ii) a record type,
(iii) a creation date, or (iv) a reliability value band.

16. The method of claim 10, wherein controlling execution of the designated artificial intelligence application comprises restricting use of the artificial intelligence application to data segments having segment-level reliability metrics that satisfy a predefined threshold.

17. The method of claim 10, wherein controlling execution of the designated artificial intelligence application comprises preventing execution of the artificial intelligence application for structured data records having record-level reliability scores below a predefined threshold.

18. The method of claim 10, wherein the artificial intelligence application comprises a generative language model configured to generate text based on structured data stored in the database system.

19. One or more non-transitory computer-readable media having an instruction stored thereon for performing a computer-implemented method performed by at least one processor in communication with a database system storing structured data records, the method comprising:
identifying a designated artificial intelligence application configured to use data stored in the database system;
identifying a plurality of database fields associated with the designated artificial intelligence application;
for each of the plurality of database fields, determining:
(i) a field utilization percentage,
(ii) a distinct value density percentage, and (iii) a freshness value based on update timing associated with the field;
determining, for each of the plurality of database fields, a generative risk value based at least in part on the field utilization percentage and the freshness value;
for each structured data record, determining a record-level reliability score based on one or more of:
(i) the generative risk values of fields included in the structured data record,
(ii) a completeness value associated with the structured data record, and
(iii) a freshness value associated with the structured data record;
dividing the structured data records into a plurality of data segments;
for each of the plurality of data segments, determining a segment-level reliability metric based on an aggregation of record-level reliability scores for structured data records included in the data segment;
storing the generative risk values, the record-level reliability scores, and the segment-level reliability metrics as data reliability indicators within the database system; and
controlling execution of the designated artificial intelligence application based on the segment-level reliability metric.

20. The one or more non-transitory computer-readable media of claim 19, wherein the field utilization percentage represents a percentage of structured data records in which a field contains a non-empty value.
